(19) United States
(12) Patent Application Publication
(10) Pub. No.: US 2024/0224069 A1
(43) Pub. Date: Jul. 4, 2024

(54) COMMUNICATION TERMINAL AND CONTROL METHOD

(71) Applicant: SHARP KABUSHIKI KAISHA, Sakai City, Osaka (JP)

(72) Inventors: HIROKAZU KOBAYASHI, Sakai City, Osaka (JP); HIROKI KASHIWAGI, Sakai City, Osaka (JP)

(21) Appl. No.: 18/563,064

(22) PCT Filed: Feb. 25, 2022
(86) PCT No.: PCT/JP2022/007790

§ 371 Date: Nov. 21, 2023

(30) Foreign Application Priority Data
May 25, 2021 (JP) 2021-087476

(51) Int. Cl. H04W 16/28; H04B 17/318; H04W 88/02

(52) U.S. Cl. CPC H04W 16/28; H04B 17/328; H04W 88/02

(57) ABSTRACT

A communication terminal and a control method that can provide a situation with good reception sensitivity are provided. A communication terminal that communicates with a base station includes an antenna that can transmit and/or receive a plurality of beams having directivity in different directions; a communication unit that communicates with the base station through the plurality of beams using the antenna and detects a received level of each of the plurality of beams; and a control unit that signals an indication prompting to change an orientation of the communication terminal based on the detected received level and directivity data indicating a received level of each of the plurality of beams in a corresponding plurality of directions.

### TECHNICAL FIELD

The disclosure relates to a communication terminal and a control method.

This application claims priority based on Japanese Patent Application No. 2021-087476 filed in Japan on May 25, 2021, the content of which is incorporated herein.

### BACKGROUND ART

A terminal apparatus that includes a plurality of antennas arranged at different positions and a display unit that displays display information regarding the position of at least one of the plurality of antennas as necessary is known (see, for example, Patent Document 1).

### CITATION LIST

### Patent Literature

Patent Document 1: WO 2017/169016

### SUMMARY

### Technical Problem

In the terminal apparatus described in Patent Document 1, the position of an antenna of the terminal apparatus being used at that time is displayed and the user can prevent deterioration of communication quality by holding the terminal apparatus such that the antenna is not blocked.

However, in the terminal apparatus described in Patent Document 1, a communication terminal is not necessarily oriented in an optimal direction and may have poor reception sensitivity, depending on a positional relationship with a base station with which it is communicating at the time.

It is an object of an aspect of the disclosure to provide a communication terminal and a control method that can provide a situation with good reception sensitivity.

### Solution to Problem

A communication terminal according to an aspect of the disclosure is a communication terminal that communicates with a base station and includes an antenna that can transmit and/or receive a plurality of beams having directivity in different directions; a communication unit that communicates with the base station through the plurality of beams by using the antenna and detects a received level of each of the plurality of beams; and a control unit that signals an indication prompting to change an orientation of the communication terminal based on the detected received level and directivity data indicating a received level of each of the plurality of beams in a corresponding plurality of directions.

A control method according to an aspect of the disclosure is a method of controlling a communication terminal that communicates with a base station and includes communicating, by using an antenna that can transmit and/or receive a plurality of beams having directivity in different directions, with the base station through the plurality of beams; detecting a received level of each of the plurality of beams; and signaling an indication prompting to change an orientation of the communication terminal based on the detected received level and directivity data indicating a received level of each of the plurality of beams in a corresponding plurality of directions.

### BRIEF DESCRIPTION OF DRAWINGS

FIG. 1 is a view illustrating an example of a configuration diagram of a system and communication according to an embodiment.

FIG. 2 is an example of a configuration diagram of a communication terminal according to an embodiment.

FIG. 3 is an example of an external view of the communication terminal according to an embodiment.

FIG. 4 is a view illustrating an example of a beam radiation diagram of the communication terminal according to an embodiment.

FIG. 5 is a view showing an example of directivity data of beams according to an embodiment.

FIG. 6 is an example of a flowchart of a control method according to an embodiment.

FIG. 7 illustrates an example of the arrangement of the communication terminal and a base station according to an embodiment.

FIG. 8 illustrates the example of the arrangement of the communication terminal and a base station according to an embodiment.

### DESCRIPTION OF EMBODIMENTS

Embodiments will be described below with reference to the drawings. In the drawings, the same or equivalent elements are denoted by the same reference numerals and duplicate description will be omitted.

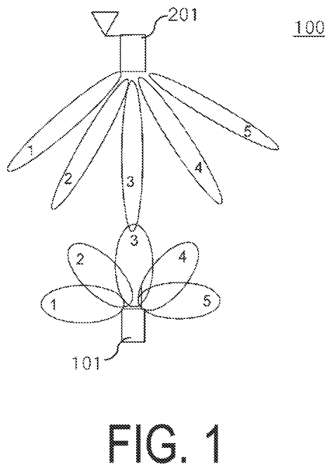

FIG. 1 is a view illustrating an example of a configuration diagram of a system and communication according to an embodiment.

The system 100 includes a communication terminal 101 and a base station 201. Although the system 100 may include other base stations, the illustration of base stations other than the base station 201 is omitted to simplify the description. The description of FIG. 1 will be given with respect to a case where communication is performed between the communication terminal 101 and the base station 201.

The communication terminal 101 supports beamforming and can transmit or receive radio waves (a beam) in a specific direction. For example, the communication terminal 101 is capable of transmitting and/or receiving a plurality of beams 1 to 5 having directivity in different directions and communicates with the base station 201 using one of the plurality of beams 1 to 5.

The base station 201 supports beamforming and can transmit or receive radio waves in a specific direction. For example, the base station 201 is capable of transmitting and/or receiving a plurality of beams 1 to 5 having directivity in different directions and sequentially transmits the beams 1 to 5 using a specific cycle. The base station 201 communicates with the communication terminal 101 using one of the plurality of beams 1 to 5.

In FIG. 1, the beam 3 that can be transmitted and/or received by the communication terminal 101 has directivity in a direction in which the base station 201 is located (an upward direction in FIG. 1) when viewed from the communication terminal 101 and the beam 3 that can be transmitted and/or received by the base station 201 has directivity in a direction in which the communication terminal 101 is located when viewed from the base station 201 (a downward direction in FIG. 1). Thus, the communication terminal 101 and the base station 201 communicate with each other using the beam 3 to improve reception quality.

In FIG. 1, to simplify the description, it is assumed that the communication terminal 101 and the base station 201 are each capable of transmitting and/or receiving five beams 1 to 5, to which an embodiment is not limited.

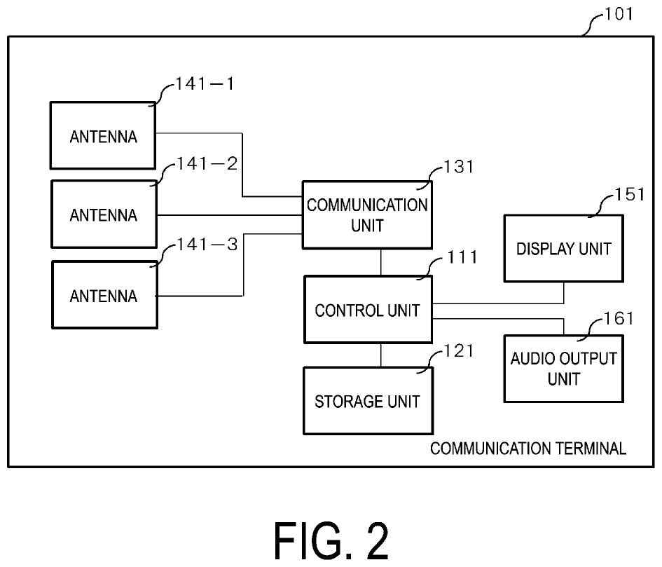

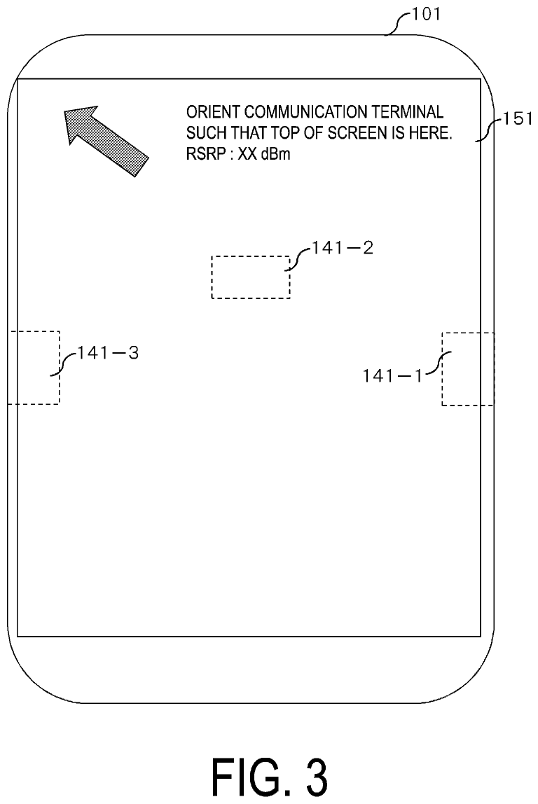

FIG. 2 is an example of a configuration diagram of the communication terminal according to the embodiment. FIG. 3 is an example of an external view of the communication terminal according to the embodiment.

The communication terminal 101 includes a control unit 111, a storage unit 121, a communication unit 131, array antennas (antennas) 141-i (where i=1 to 3), a display unit 151, and an audio output unit 161. The communication terminal 101 is, for example, a smartphone, a tablet, or a portable router.

The control unit 111 controls the operation of the communication terminal 101. For example, the control unit 111 signals an indication prompting to change the orientation of the communication terminal 101 based on detected received levels and directivity data indicating the received levels of a plurality of beams in each of a plurality of directions. For example, the control unit 111 determines whether there is a beam among the plurality of beams whose received level is improved over a beam currently used for communication in a case that the orientation of the communication terminal 101 is changed and signals an indication prompting to change the orientation of the communication terminal 101 in a case that the control unit 111 determines that there is a beam whose received level is improved. For example, the control unit 111 displays an orientation of the communication terminal 101 in which the received level is improved on the display unit 151 in a case that the control unit 111 determines that there is a beam whose received level is improved. For example, the control unit 111 audibly outputs an indication prompting to change the orientation of the communication terminal 101 through the audio output unit 161.

The control unit 111 is implemented, for example, by a processor such as a Central Processing Unit (CPU) or a logic circuit (hardware) formed on an integrated circuit (an Integrated Circuit (IC) chip) or the like.

The storage unit 121 is a storage apparatus that stores programs, data, and the like used by the communication terminal 101. The storage unit 121 is, for example, a Read Only Memory (ROM) or a Random Access Memory (RAM). The storage unit 121 stores directivity data regarding a plurality of beams of each antenna 141-i. Details of the directivity data will be described later.

The communication unit 131 performs processing relating to communication between the communication terminal 101 and other apparatuses (for example, base stations). For example, the communication unit 131 transmits a transmission signal input from the control unit 111 through the antennas 141-i as radio waves (a beam) and outputs a reception signal received via the antenna 141-i to the control unit 111. The communication unit 131 transmits and/or receives various data, for example, using millimeter waves as carrier waves. The communication unit 131 also controls the directivity of the antenna 141-i. The communication unit 131 is implemented, for example, by a processor such as a CPU or a logic circuit (hardware) formed on an integrated circuit (an IC chip) or the like.

Each of the antennas 141-i includes a plurality of antenna elements and the plurality of antenna elements are regularly arranged in a predetermined direction at predetermined intervals. The antenna 141-i emits radio waves (a beam) based on a transmission signal from the communication unit 131. The antenna 141-i outputs, to the communication unit 131, a received signal based on radio waves that have arrived. The antenna 141-i is capable of outputting a plurality of beams having directivity in different directions. However, the antenna 141-i cannot output a plurality of beams at the same time, and for example, switches the output beams at regular intervals. The antenna 141-i is, for example, a microstrip antenna.

In FIG. 3, in a case that the communication terminal 101 is viewed from the front (from the display unit 151 side), the antenna 141-1 is installed at a midpoint of the right side of the communication terminal 101, the antenna 141-2 is installed slightly above the center of the communication terminal 101, and the antennas 141-3 is installed at a midpoint of the left side of the communication terminal 101.

The antennas 141-i are indicated by broken lines in FIG. 3 because the antennas 141-i are present inside the communication terminal 101 and are invisible from the outside. The number and positions of the antennas 141-i in the embodiment are examples, to which an embodiment is not limited.

The display unit 151 displays various information. The display unit 151 is, for example, a liquid crystal panel or an organic Electro-Luminescence (EL) panel. In FIG. 3, the display unit 151 displays the value (XX dBm) of Reference Signal Received Power (RSRP) indicating the received level of a beam. The display unit 151 also displays a message prompting to change the orientation of the communication terminal 101 “ORIENT COMMUNICATION TERMINAL SUCH THAT TOP OF SCREEN IS HERE” and an arrow indicating in which direction the communication terminal 101 is to be oriented.

The audio output unit 161 audibly outputs various information. The audio output unit 161 is, for example, a speaker.

The communication terminal 101 measures the RSRP of each of its received beams and stores directivity data regarding each beam in the storage unit 121 in advance and changes the orientation of each antennas 141-i such that another beam is changed to an optimal beam by changing the orientation of the communication terminal 101 based on the RSRP of a beam currently being received as an optimal beam and RSRPs of other beams and finally calculates a direction that gives a better RSRP value and prompts the user to change the orientation of the communication terminal 101 through the display unit 151 or the like.

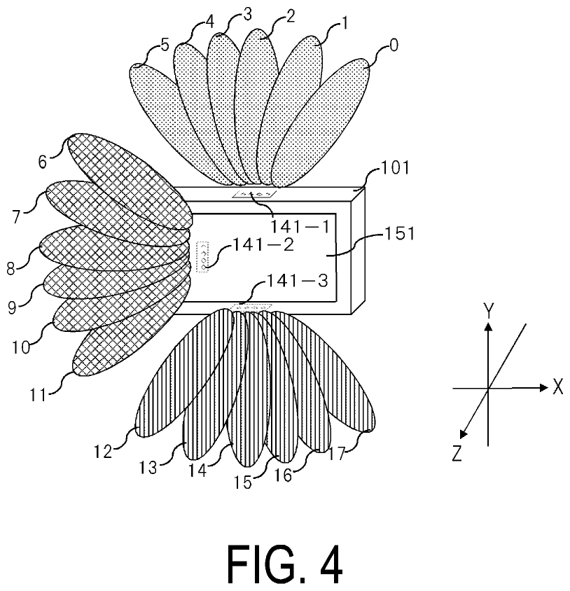

FIG. 4 is a view illustrating an example of a beam radiation diagram of the communication terminal according to the embodiment.

FIG. 4 schematically illustrates beams transmitted and/or received by the antennas 141-i. Each antenna 141-i transmits and/or receives six beams in different directions. As is seen from coordinate axes illustrated in FIG. 4, a longitudinal direction of the communication terminal 101 which is rectangular when viewed from the front is defined as an X axis direction, a lateral direction thereof is defined as a Y axis direction, and a direction from a back surface on which the display unit 151 is not provided to a front surface on which the display unit 151 is provided is defined as a Z axis direction.

The antenna 141-1 is oriented in a positive direction of the Y axis and transmits and/or receives beams 0 to 5 within an XY plane mainly in the positive direction of the Y axis while slightly changing each direction. The antenna 141-2 is oriented in a positive direction of the Z axis and transmits and/or receives beams 6 to 11 within a YZ plane mainly in the positive direction of the Z axis while slightly changing each direction. The antenna 141-3 is oriented in a negative direction of the Y axis and transmits and/or receives beams 12 to 17 within the XY plane mainly in the negative direction of the Y axis while slightly changing each direction. The storage unit 121 also stores information on which beams each antenna 141-i can transmit and/or receive. For example, the storage unit 121 stores information indicating that the antennas 141-1 to 141-3 can transmit and/or receive the beams 0 to 5, 6 to 11, and 12 to 17, respectively. The storage unit 121 also stores information on the direction in which each antenna 141-i is oriented or installed in the communication terminal 101. The storage unit 121 also stores information on which direction of the communication terminal 101 each of the beams 0 to 5, 6 to 11, and 12 to 17 corresponds to.

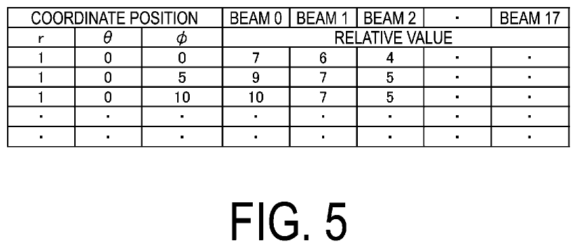

FIG. 5 is a view showing an example of directivity data of beams according to the embodiment.

For example, the directivity data shown in FIG. 5 is stored in the storage unit 121 in advance. The directivity data indicates the characteristics of each beam measured in advance and specifically indicates the relative power values of the beams 0 to 17 at each coordinate position in spherical coordinates whose origin is the center of the communication terminal 101. That is, the directivity data indicates the received level of each beam for each of a plurality of directions. The directivity data is recorded with each coordinate position (r, θ, φ) being associated with the relative power values. Namely, the directivity data is data indicating in which direction in the XYZ space each of the beams 0 to 17 is most suitable for communication. In the directivity data, r is a radius, θ is the angle between the Z axis and the radius, and φ is the angle between the X axis and the projection of the radius onto the XY plane. In the directivity data, the relative power value of each beam corresponding to a coordinate position (r, θ, φ) indicates the relative power value of each beam in a direction from the origin to a point indicated by the coordinate position (r, θ, φ) (i.e., a direction from the origin, indicated by θ and φ).

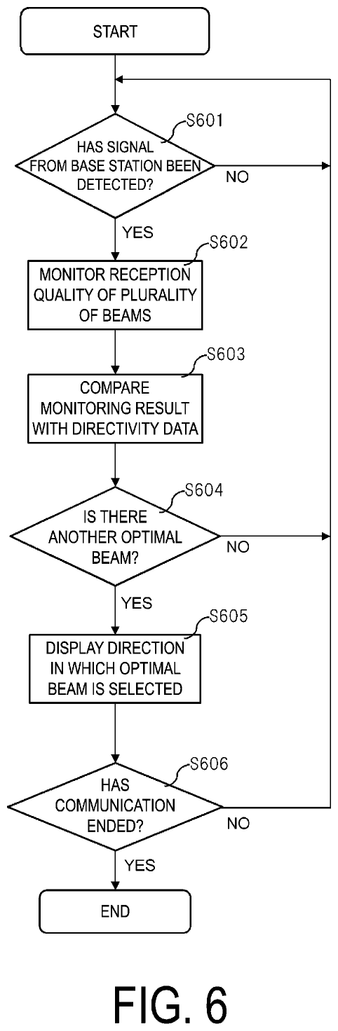

FIG. 6 is an example of a flowchart of a control method according to the embodiment.

In step S601, the communication unit 131 waits to detect a signal from the base station 201, and in a case that a signal from the base station 201 is detected, control proceeds to step S602.

In step S602, the communication unit 131 monitors received levels (for example, RSRPs) of a signal from the base station 201 through a plurality of beams. For example, the communication unit 131 receives a signal from the base station 201 through a plurality of beams in different directions and monitors the received levels of the signal from the base station 201 at the plurality of beams. The communication unit 131 outputs the monitoring result to the control unit 111. The plurality of beams are, for example, beams 0 to 17. Specifically, the currently received levels of beams 0 to 17 obtained as a result of monitoring are, for example, a received level of −75 dBm of the beam 0, a received level of −78 dBm of the beam 1, a received level of −80 dBm of the beam 2, and the like.

In step S603, the control unit 111 compares the monitoring result of step S602 with the directivity data stored in the storage unit 121.

In step S604, the control unit 111 determines whether there is an optimal beam other than the currently used beam based on the comparison result of step S603 and control proceeds to step S605 in a case that the control unit 111 determines that there is an optimal beam and returns to step S601 in a case that the control unit 111 determines that there is no optimal beam. The optimal beam is, for example, a beam whose received level is improved over the beam currently used for communication in a case that the orientation of the communication terminal is changed.

Specifically, for example, the control unit 111 calculates the current orientation of the communication terminal 101 from differences between the received levels of the beams 0 to 17 obtained in step S602 and the relative power values of the beams at each coordinate position in the directivity data shown in FIG. 5. For example, for the coordinate position (1, 0, 0) in the directivity data shown in FIG. 5, the control unit 111 calculates a sum of the differences between the received levels of the beams 0 to 17 received in step S602 and the relative power values of the beams 0 to 17 at the coordinate position (1, 0, 0) in the directivity data shown in FIG. 5 as an evaluation value of the coordinate position (1, 0, 0). Specifically, the control unit 111 calculates a sum of the difference between the relative power value (=7) of the beam 0 at the coordinate position (1, 0, 0) and the received level (=−75) of the beam 0 received in step S602, the difference between the relative power value (=6) of the beam 1 and the received level (=−78) of the beam 1 received in step S602, . . . , and the difference between the relative power value of the beam 17 at the coordinate position (1, 0, 0) and the received level of the beam 17 received in step S602 as an evaluation value of the coordinate position (1, 0, 0). Similarly, the control unit 111 calculates evaluation values for other coordinate positions.

The control unit 111 calculates a coordinate position with the smallest evaluation value among the calculated evaluation values of the coordinate positions as the current orientation of the communication terminal 101. Then, the control unit 111 calculates a beam which has the highest relative power value at the coordinate position with the smallest evaluation value calculated as the current orientation of the communication terminal 101 as an optimal beam. In a case that the optimal beam differs from the currently used beam, the control unit 111 determines that there is an optimal beam other than the currently used beam. In a case that the optimal beam is the same as the currently used beam, the control unit 111 determines that there is no optimal beam other than the currently used beam. Specifically, for example, in a case that the coordinate position (1, 0, 0) is calculated as the current orientation of the communication terminal 101 and the beam currently used by the communication terminal 101 is the beam 2, the control unit 111 selects the beam 0 with the highest relative power value as an optimal beam because the relative power values of the beams 0, 1, and 2 at the coordinate position (1, 0, 0) in the directivity data shown in FIG. 5 are 7, 6, and 4, respectively (assuming that the relative power values of the beams 3 to 17 are 4 or less) and determines that there is an optimal beam other than the currently used beam because the selected beam 0 differs from the beam 2 currently used by the communication terminal 101.

In step S605, the control unit 111 signals an indication prompting to change the orientation of the communication terminal 101. Specifically, for example, the control unit 111 displays the direction in which the optimal beam is selected (for example, an arrow indicating the direction in which the top of the communication terminal 101 is to be oriented as illustrated in FIG. 3) on the display unit 151. The direction in which the optimal beam is selected is, for example, the direction of the optimal beam calculated in step S604. The control unit 111 may audibly output the direction in which the optimal beam is selected through the audio output unit 161 instead of or in addition to displaying the direction in which the optimal beam is selected. In the case of outputting audio, the control unit 111 may change the volume or frequency of the audio depending on the direction in which the optimal beam is selected. The control unit 111 may also signal an indication prompting to change the orientation of the communication terminal, for example, by blinking an LED (not illustrated) included in the communication terminal 101 instead of or in addition to displaying the direction in which the optimal beam is selected.

In step S606, the control unit 111 determines whether communication has ended and ends the control method of FIG. 6 in a case that the control unit 111 determines that communication has ended, and the control returns to step S601 in a case that the control unit 111 determines that communication has not ended.

Here, an example of beam selection by the communication terminal 101 will be described.

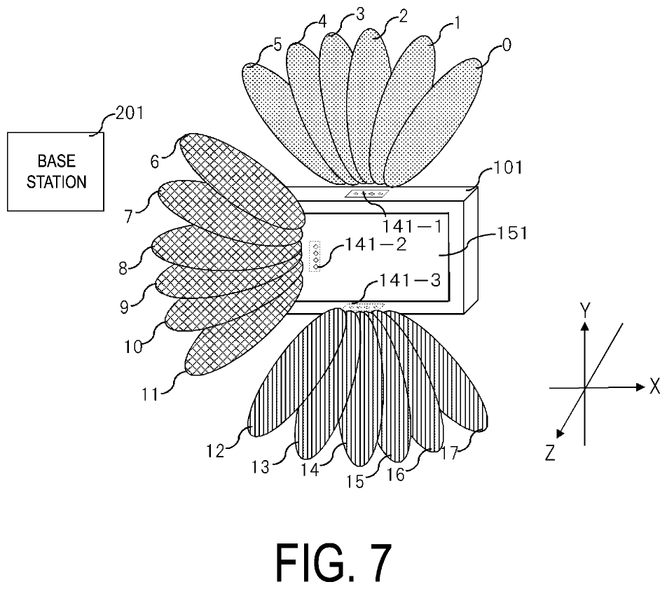

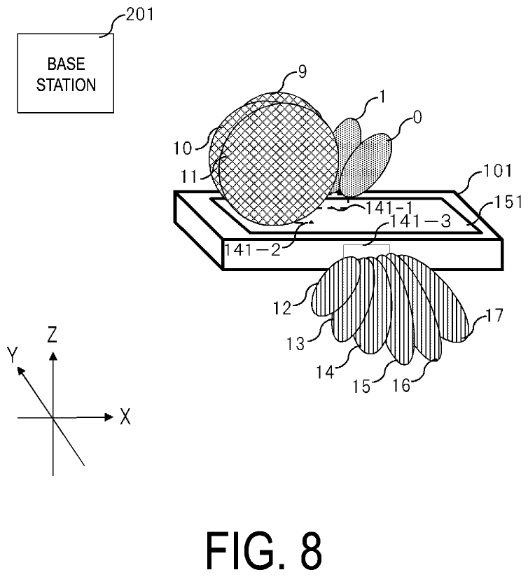

FIG. 7 and FIG. 8 illustrate an example of the arrangement of the communication terminal and a base station according to the embodiment. FIG. 7 is a view corresponding to FIG. 4 with a base station 201 added and FIG. 8 is a view corresponding to FIG. 7 where the communication terminal 101 and the base station 201 are viewed from a different direction. In FIG. 8, some of the beams are not illustrated due to the viewing from the different direction.

In FIG. 7 and FIG. 8, in a case that the base station 201 is located above (away in the positive direction of the Z axis from) a horizontal plane (a surface where the display unit 151 is provided) of the communication terminal 101 and facing a short side of the communication terminal 101 where the antenna 141-2 is provided (on the negative direction side of the X axis), the reception quality of the antenna 141-2 is high and a beam of the antenna 141-2 is selected. However, it is calculated in step S604 that there is another optimal beam, because communication can be performed with better reception quality by orienting the antenna 141-1 toward the base station 201.

The communication terminal according to the embodiment ensures that even an apparatus equipped with a limited number of highly directional millimeter-wave antennas can inform the user of a method (for example, an orientation of the communication terminal 101) for improving reception sensitivity. Thereby, it is possible to provide a situation in which reception sensitivity is improved by the user orienting the communication terminal 101 in a presented direction.

It is to be noted that the disclosure can be modified without being limited to the embodiment described above and each configuration described above can be replaced with substantially the same configuration, a configuration that has the same effects, or a configuration that can achieve the same object.

1. A communication terminal configured to communicate with a base station, the communication terminal comprising:
an antenna configured to transmit and/or receive a plurality of beams having directivity in different directions;
a communication unit configured to communicate with the base station through the plurality of beams by using the antenna and detect a received level of each of the plurality of beams; and
a control unit configured to signal an indication prompting to change an orientation of the communication terminal based on the detected received level and directivity data indicating a received level of each of the plurality of beams in a corresponding plurality of directions.

2. The communication terminal according to claim 1,
wherein the control unit
determines whether there is a beam among the plurality of beams whose received level is improved over a beam currently used for communication in a case that the orientation of the communication terminal is changed; and
signals an indication prompting to change the orientation of the communication terminal in a case that the control unit determines that there is the beam whose received level is improved.

3. The communication terminal according to claim 2,
wherein the control unit displays an orientation of the communication terminal where the received level is improved on a display unit in a case that the control unit determines that there is the beam whose received level is improved.

4. The communication terminal according to claim 1,
wherein the control unit audibly outputs an indication prompting to change the orientation of the communication terminal through an audio output unit.

5. A method of controlling a communication terminal configured to communicate with a base station, the method comprising:
communicating, by using an antenna configured to transmit and/or receive a plurality of beams having directivity in different directions, with the base station through the plurality of beams;
detecting a received level of each of the plurality of beams; and
signaling an indication prompting to change an orientation of the communication terminal based on the detected received level and directivity data indicating a received level of each of the plurality of beams in a corresponding plurality of directions.
